(19) United States
(12) Patent Application Publication
(10) Pub. No.: US 2012/0089938 A1
(43) Pub. Date: Apr. 12, 2012

(54) Information Processing Apparatus, Information Processing Method, and Program

(76) Inventors: Fuminori HOMMA, Tokyo (JP); Tatsushi Nashida, Kanagawa (JP)

(21) Appl. No.: 13/235,809

(22) Filed: Sep. 19, 2011

(30) Foreign Application Priority Data
Oct. 8, 2010 (JP) P2010-228461

(51) Int. Cl. G06F 3/048

(52) U.S. Cl. 715/776

(57) ABSTRACT

An apparatus for displaying content stored as a plurality of pages is provided. The apparatus comprises a detection unit configured to detect a first user operation and a control unit configured to send signals to display one of the plurality of pages on a screen. The control unit is further configured to, when the detected first user operation comprises a page turn instruction, send signals to sequentially change the displayed page at a first rate when the displayed page is outside a first number of pages before or after a first marked page and sequentially change the displayed page at a second rate slower than the first rate when the displayed page is within the first number of pages before or after the first marked page.

### BACKGROUND

The present disclosure relates to an information processing apparatus, an information processing method and a program for displaying a content of an electronic book and the like on a display screen such as a touch panel.

A terminal apparatus such as an electronic book reader that displays electronic books including characters and figures is known. Such a terminal apparatus is demanded to enable a user to view electronic books with good operability, and various display methods, GUIs (Graphical User Interfaces), etc, for an electronic book, onto which, for example, an action performed when the user reads an actual book is reflected, are being developed.

For example, when an actual (or physical) book is read, an action of searching for a desired page while turning pages is often performed. As an operation based on this action, there is known a page scrolling operation for searching for a desired page from a plurality of pages in an electronic book.

For example, Japanese Patent Application Laid-open No. 2006-313485 (hereinafter, referred to as Patent Document 1) discloses an electronic book displaying apparatus. In this electronic book displaying apparatus, pages in an electronic book are displayed as thumbnails. The user can scroll the pages while viewing those thumbnails displayed on a screen in order to search for a desired page (see paragraph [0029], FIG. 1, and the like in Patent Document 1).

Further, Japanese Patent Application Laid-open No. 2008-234372 (hereinafter, referred to as Patent Document 2) discloses a mobile device. In this mobile device, in an outer edge of the display screen that displays a content of the electronic book, there is provided a horizontal touch sensor and a vertical sensor. The user can scroll the pages by performing various touch operations with respect to the touch sensors (see paragraph [0023], FIG. 1, and the like in Patent Document 2).

### SUMMARY

With the page scrolling operation disclosed in Patent Document 1, if the electronic hook includes only text data, it is difficult to identify the pages by viewing the plurality of thumbnails. Further, there is a limitation on the number of thumbnail images to be displayed at a time. As a result, it is difficult to search for a desired page from an electronic book including a large number of pages with high speed.

Further, with the page scrolling operation disclosed in Patent Document 2, if the electronic book includes a large number of pages, resolution of the touch sensors in page searching is lowered. Therefore, it is difficult to search for a desired page in a pinpoint manner. That is, with the page scrolling operations disclosed in Patent Documents 1 and 2, it is difficult to search for a desired page in a short time and good operability.

In view of the above-mentioned circumstances, there is a need for providing an information processing apparatus, an information processing method, and a program, which are capable of searching for a desired page in an electronic book with good operability in a short time.

In one exemplary embodiment, the present disclosure is directed towards an apparatus for displaying content stored as a plurality of pages. The apparatus comprises a detection unit configured to detect a first user operation and a control unit configured to send signals to display one of the plurality of pages on a screen. The control unit is further configured to, when the detected first user operation comprises a page turn instruction, send signals to sequentially change the displayed page at a first rate when the displayed page is outside a first number of pages before or after a first marked page and sequentially change the displayed page at a second rate slower than the first rate when the displayed page is within the first number of pages before or after the first marked, page.

In another exemplary embodiment, the present disclosure is directed towards a method comprising detecting a first user operation and displaying one of a plurality of pages of content on a screen. The method further comprises, when the detected first user operation comprises a page turn instruction, sequentially changing the displayed page at a first rate when the displayed page is outside a first number of pages before or after the marked page and sequentially changing the displayed page at a second rate slower than the first rate when the displayed page is within the first number of pages before or after the marked page.

In yet another exemplary embodiment, the present disclosure is directed towards a tangibly embodied non-transitory computer-readable medium storing instructions which, when executed by a processor, perform a method comprising detecting a first user operation. The method further comprises displaying one of a plurality of pages of content on a screen. The method further comprises, when the detected first user operation comprises a page turn instruction, sequentially changing the displayed page at a first rate when the displayed page is outside a first number of pages before or after the marked page and sequentially changing the displayed page at a second rate slower than the first rate when the displayed page is within the first number of pages before or after the marked page.

As described above, according to the embodiments of the present disclosure, it is possible to search for a desired page in an electronic book with good operability in a short time.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a view schematically showing an outer appearance of a portable terminal as an information processing apparatus according to a first embodiment of the present disclosure;

PIG. 2 is a block diagram showing a configuration example of the portable terminal shown in FIG. 1;

FIG. 3 are views for describing an image of an attention page displayed on a display screen shown in FIG. 1;

FIG. 4 is a flowchart showing a process flow of setting a page as the attention page in the first embodiment;

FIG. 5 are views for describing the process flow shown in FIG. 4;

FIG. 6 are views for describing the process flow shown in FIG. 4;

FIG. 7 are views each schematically showing a GUI for page scrolling according to the first embodiment;

FIG. 8 is a flowchart showing a flow of a page scrolling process using the portable terminal according to the first embodiment;

FIG. 9 are a view and a graph for describing updating of a display page number in the page scrolling process of the first embodiment;

FIG. 10 is a graph showing hysteresis regions in the case where a plurality of pages within an electronic book are set as attention pages;

FIG. 11 is a graph showing hysteresis regions in the case where a plurality of pages within an electronic book are set as attention pages;

FIG. 12 are a view and a graph showing a case where a drag operation in an X-direction from a right end to a left end of an enlarged edge portion shown in FIG. 7 is performed;

FIG. 13 is a view showing hysteresis regions to be set through a portable terminal according to a second embodiment of the present disclosure;

FIG. 14 is a view showing hysteresis regions to be set through the portable terminal according to the second embodiment of the present disclosure;

FIG. 15 are views each schematically showing an edge display image to be displayed in a portable terminal as an information processing apparatus according to a third embodiment of the present disclosure;

FIG. 16 is a flowchart showing a flow of a page scrolling process using the portable terminal according to the third embodiment;

FIG. 17 are views and graphs for describing updating of a display page number in the page scrolling process of the third embodiment;

FIG. 18 is a view schematically showing another example of an image of an attention page to be displayed on a display screen of the portable terminal according to the third embodiment;

FIG. 19 is a view showing a modified example of a page switching operation region being a region that receives successive page switching instructions from a user;

FIG. 20 is a graph snowing a modified example regarding the updating of the display page number shown in FIG. 9; and

FIG. 21 is a view showing a modified example of an image of an attention page.

### DETAILED DESCRIPTION OF EMBODIMENTS

Hereinafter, embodiments of the present disclosure will be described with reference to the drawings.

### First Embodiment

Information Processing Apparatus

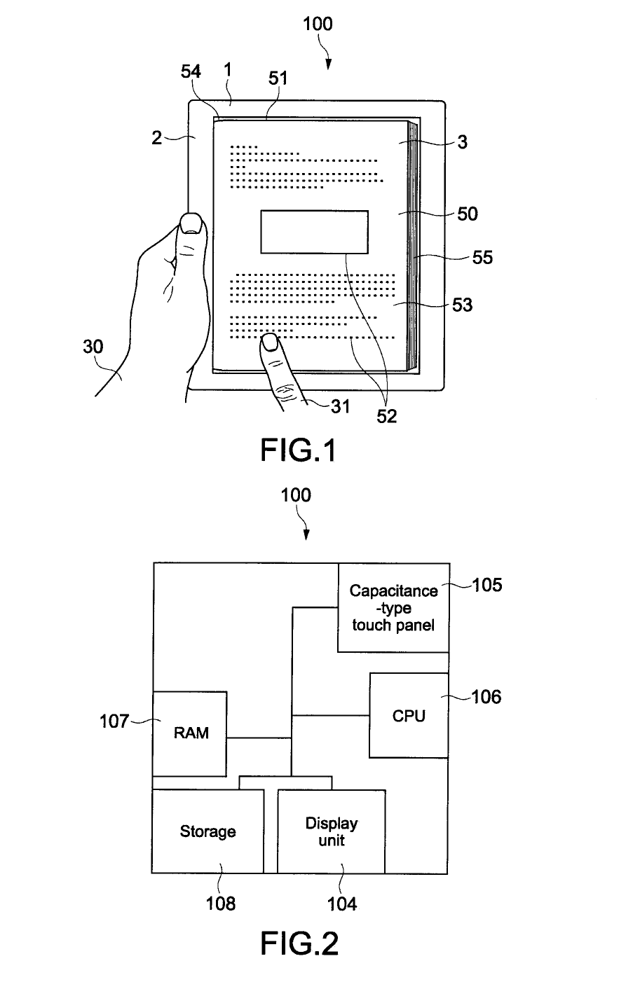

FIG. 1 is a view schematically showing an outer appearance of an information processing apparatus according to a first embodiment of the present disclosure. In this embodiment, as the information processing apparatus, a portable terminal 100 equipped with a touch panel is used. The portable terminal 100 according to this embodiment enables the electronic book 50 to be viewed.

As shown in FIG. 1, the portable terminal 100 includes a casing 1 and a display screen 3. The casing 1 is held by the user 30. The display screen 3 may be provided on a front surface 2 of the casing 1. The casing 1 is for example formed of metal such as aluminum or stainless steel or plastic. The casing 1 has a size of about 25 cm in a longitudinal direction, about 20 cm in a lateral direction, and about 1 cm in thickness as viewed in FIG. 1, that is, as viewed form a user 30, for example. However, the material and the size for the casing 1 are not limited.

The display screen 3 may be provided across substantially the entire front surface 2 of the casing 1. The electronic book 50 is displayed on the display screen 3 so as to enable a content of the electronic book 50 to be viewed.

FIG. 2 is a block diagram showing a configuration example of the portable terminal 100. The portable terminal 190 includes a display unit 104 including the display screen 3, a touch panel 105, a CPU (Central Processing Unit) 106, a RAM (Random Access Memory) 107, and a storage 108. For example, the CPU 106, the RAM 107, and an input/output interface (not shown) may be connected to one another via a bus or the like. Connected to the input/output interface are the display unit 104, the touch panel 105, and the storage 108.

The display unit 104 is a display device that uses, for example, liquid, crystal, EL (Electro-Luminescence), or CRT (Cathode Ray Tube).

The touch panel 105 functions as an input unit, that receives various instructions from the user 30. The touch panel 105 of this embodiment may be capable of detecting contact and proximity of an operator 31 such as a finger of the user 30 with respect to the display screen 3.

The touch panel 105 may include a sensor unit (not shown) integrally formed with the display screen 3, and an operation circuit unit. When the operator 31 comes close to or in contact with the display screen 3, a proximity signal or contact signal is output from the sensor unit to the operation circuit unit. Based on the output proximity signal or contact signal, the operation circuit unit generates information on the proximity position or contact position of the operator 31, information on a movement direction, movement amount, and movement speed of the operator 31, and the like. In addition, information on a contact area of the operator 31 and the like may also be generated. The various types of generated information are output to, for example, the CPU 106 to be subjected to a process.

In this embodiment, a capacitance-type touch panel 105 may be used. However, other types of touch panels such as a resistive film type, a surface acoustic wave type, and an infrared, ray type may be used instead.

The storage 108 is a nonvolatile storage device such as an HDD (Hard Disk Drive), a flash memory, and other solid-state memories. A part or ail of the RAM 107 and storage 108 may corresponds/correspond to a storage means according to this embodiment. Alternatively, it is also possible for the portable terminal 100 to include a ROM (Read Only Memory) (not shown) to constitute a storage means including the ROM.

A drive unit and a communication unit (not shown) may be provided in the portable terminal 100. The drive unit is a device capable of driving a removable recording medium such as an optical recording medium, a floppy (registered trademark) disk, a magnetic recording tape, and a flash memory.

The communication unit may include a modem, a router, and other communication devices that are capable of connecting to a LAN (Local Area Network) or a WAS (Wide Area Network) and used for communicating to other devices. Communication by the communication unit may either be by wires or wireless.

For example, an electronic book 50 stored in a recording medium is read out by the CPU 106 via the drive unit and displayed on the display screen 3. Alternatively, the electronic book 50 may be downloaded via the communication unit and displayed on the display screen 3.

Further, the portable terminal 100 of this embodiment may include a device capable of detecting a change in tilt of the portable terminal 100, such as an acceleration sensor or a gyro sensor.

Data processing by the portable terminal 100 is realized by software stored in the storage 108 and the like in cooperation with hardware resources of the portable terminal 100. Specifically, by the CPU 106 loading a program that is stored in the storage 108 and the like and constitutes software in the RAM 107 and executing it, various types of data processing are realized. In this embodiment, the CPU 106 functions as a controller capable of updating a page number and pausing updating to be described later, as an addition unit that, adds specification information to the electronic book, or as a setting unit that sets a page switching region. It should be noted that the RAM 107 includes a video RAM (VRAM) for image display (not shown).

Here, an image displayed on the display screen 3 of the portable terminal 100 according to this embodiment will be described with reference to FIG. 1. For example, the electronic book 50 read out from the recording medium or downloaded via the communication unit includes a plurality of pages to which page numbers may be assigned. Each page includes content data as a content of the page. The content data is, for example, text data and image data. Further, the electronic book 50 may include bibliographic data on a title, author, total number of pages, thickness per page, right-bind/left-bind, and the like.

FIG. 1 shows a page image 51 that expresses a shape of a page and content data 52 which may be included in a page of the electronic book 50. By mapping the content data 52 of a page to the page image 51, a display page 53 may be displayed on the display screen 3. For example, a display page 53 to which content data of, for example, a fourth page is mapped becomes a display page 53 of a fourth page in the electronic book 50.

In this embodiment, a left-bind left-hand page image 51 is displayed. On a base side of the page image 51 (left-hand side in FIG. 1), a binding portion 54 is displayed. On the other hand, on a leading end side of the page image 51 (right-hand side in FIG. 1), an edge portion 55 that expresses an edge of an actual book is displayed.

In this embodiment, the page image 51 may be generated as a mesh map composed of a plurality of polygons (not shown), and the content data 52 of each page of the electronic book 50 is provided as texture on the page image 51. By appropriately moving a position of an apex of each polygon, a moving image (animation) that a part or all of the display page 53 is turned, for example, is generated and displayed on the display screen 3.

Operation of Information Processing Apparatus

An operation of the portable terminal 100 being the information processing apparatus according to this embodiment will be described. In the portable terminal 100 according to this embodiment, a page in the electronic book can be set as an attention page. Then, the set attention page can be searched for with good operability and high speed in a short time.

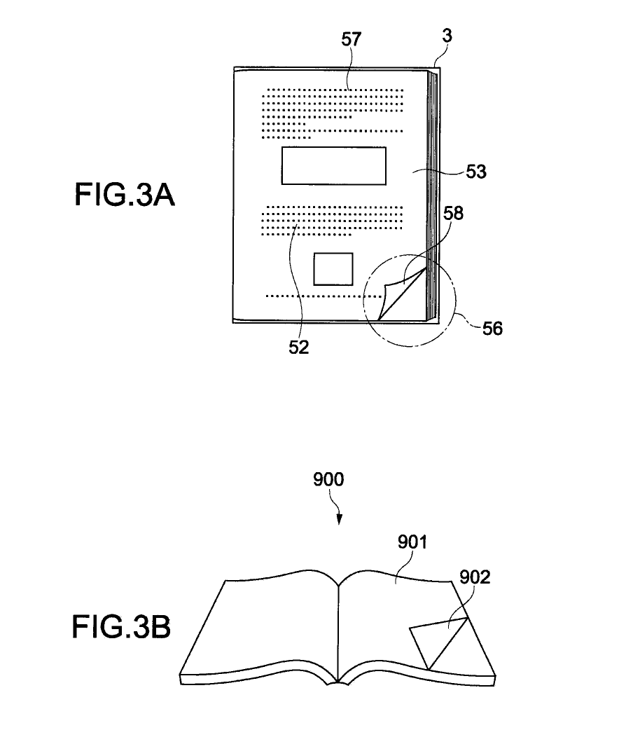

FIG. 3 are views for describing an image of an attention page displayed on the display screen 3. FIG. 3A is a view schematically showing the image of the attention page, and FIG. 3B is a view schematically showing a page of an actual book.

For example, the user 30 sets a page in the electronic book 50 as an attention page including attention content data 52. Then, specification information that specifies the number of the page set as the attention page may be added to the electronic book 50. For example, specification information may be added into the bibliographic data of the electronic book 50 as described above. Alternatively, a table that manages the attention page number may be generated as specification information and added to the electronic book. Further, the specification information that specifies the attention page number may be stored in the storage 108 or the like.

In this embodiment, as shown FIG. 3A, an image including a part of a lower right part 56 of the display page 53, which is folded back, is displayed as an image 57 of the attention page. As shown in FIG. 3B, in an actual book 900, the user sometimes bends an end portion of a page 901 to make a so-called dog-ear (i.e., a page corner fold) 902. Alternatively, the user may make a mark that resembles any other suitable type of indicator including, for example, a bookmark, or a sticky note. In this embodiment, the image of the attention page 57 including a dog-ear portion 58 that expresses the dog-ear 902 made in the actual book 300 may be generated.

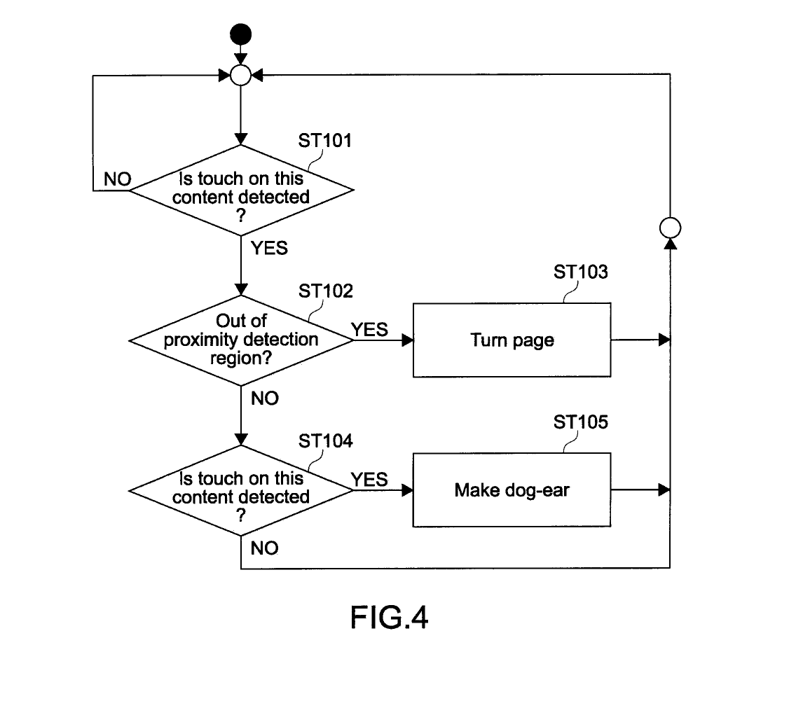

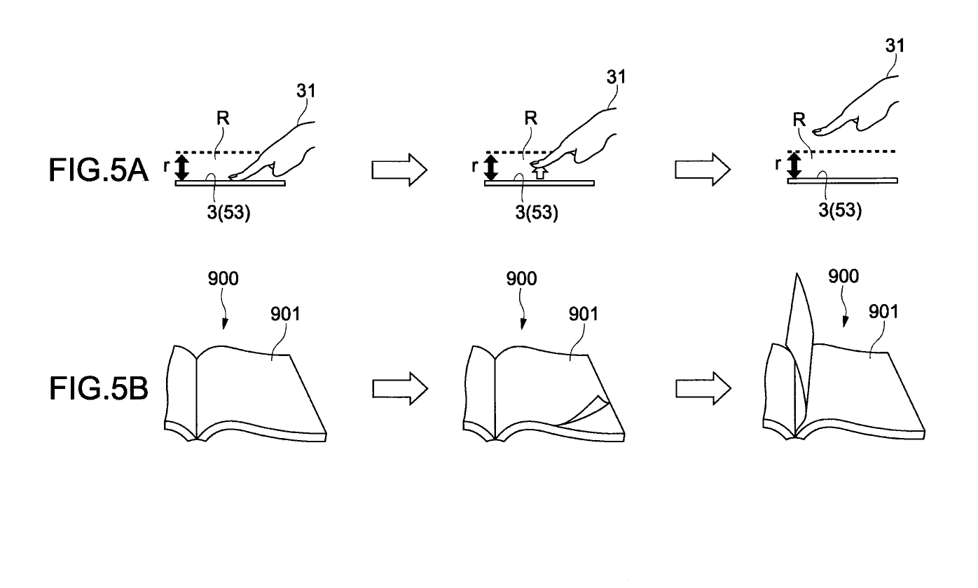

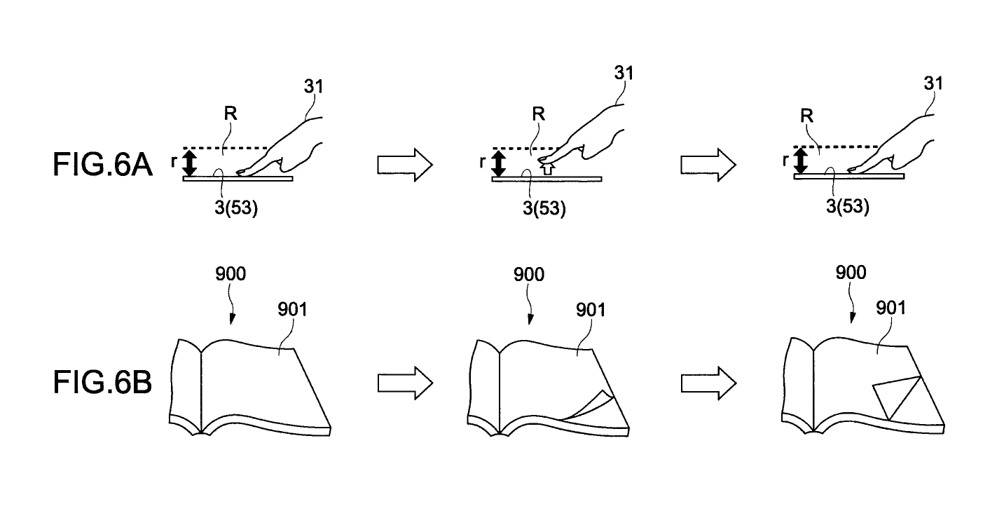

FIG. 4 is a flowchart showing a process flow of setting a page as an attention page. FIGS. 5 and 6 are views for describing the process flow. FIG. 5A and FIG. 6A are schematic views each showing a user operation including at least one touch operation with respect to the display screen 3. Although a touch operation is shown in FIGS. 5A and 6A, it is to be understood that a user operation is not confined to a touch operation on a touch screen. For example, the user operation may include operations conducted with any suitable input apparatus, such as, for example, a button, mouse, trackball, touchpad, lever, joystick or switch.

FIG. 5B and FIG. 6B are views for describing an animation that expresses a deformation of the display page 53 corresponding to the touch operation shown in FIG. 5A and FIG. 6A. In FIG. 5B and FIG. 6B, an operation of the page 901 in the actual book 900 is shown, and an animation based on the page operation of the actual book 900 may be displayed on the display screen 3. It should be noted that the touch operation includes various operations with respect to the display screen 3 using the operator 31, such as a touch operation of simply bringing the operator 31 into contact with the display screen 3, a drag operation, and a tap operation.

The following description concerns, among other things, determining whether or not a user operation is a page turn instruction for turning a page or a mark operation for marking a page. First, it may be determined whether or not a touch operation with respect to the display page 53 (content) of the electronic book 50 is detected (Step 101). A touch operation may be implemented by the user using, for example, a user control member such as a finger, stylus or pen. As shown in FIGS. 5 and 6, under a state in which the operator 31 is in contact with the display screen 3 immediately after the touch operation by the operator 31 with respect to the display page 53 is performed, the display page 53 is not yet changed.

It may be determined whether or not the operator 31 goes out of a proximity detecting region R (Step 102). The proximity detecting region R means a region in which the touch panel 105 can detect the proximity operation of the operator 31, and is a region extending from the display screen 3 to a position spaced from the display screen 3 by a distance r. As shown in FIGS. 5 and 6, when the operator 31 separates from the display screen 3 and moves in the proximity detecting region R, the user operation is determined to be a page turn instruction and an animation that the display page 53 is turned little by little in accordance with this operation is displayed on the display screen 3.

When it is determined that the operator 31 goes out of the proximity detecting region R (Yes in Step 102), a tap operation with respect to the display page 53 is determined. In this embodiment, as shown in FIG. 5, a page turning process to the subsequent page may be allocated to the tap operation with respect to the display page 53 (Step 103).

When it is determined that the operator 31 does not go out of the proximity detecting region R (No in Step 102), it may be determined whether or not a second touch operation is performed with respect to the display page 53 (Step 104). When the second touch operation with respect to the display page 53 is detected, as shown in FIG. 6, the dog-ear portion 58 may be generated (Step 105). That is, the display page 53 is set as the attention page, or marked, and on the display screen 3, an image of the attention page 57 including the dog-ear portion 58 is displayed. It should be noted that when the second touch operation is performed after the operator 31 moves by a distance in a page-turn direction in the proximity detecting region R, for example, the dog-ear portion 58 may be formed.

When the second touch operation with respect to the display page 53 is detected for a period of time is not detected (No in Step 104), it is determined that an instruction by the touch operation is cancelled, and the image of the original display page 53 is displayed.

As described, above, in the method of setting the attention page according to this embodiment, by an intuitive operation based on the operation for forming the dog-ear 902 in the actual book 900, a page can be set as the attention page. Then, the image of the attention page 57 including the dog-ear portion 58 can be displayed on the display screen 3. Further, by appropriately utilising the proximity detecting region R, it is possible to avoid a conflict in operation against a tap operation allocated to a page switching process. Therefore, the attention page can be set with good operability.

It should be noted that the method of setting the attention page is not limited to that as described above. In accordance with another touch operation with respect to the display screen 3 or the display page 53, the attention page may be set. Alternatively, an icon or the like for setting the attention page may be displayed and the user 30 may click that icon or the like, to thereby set the attention page.

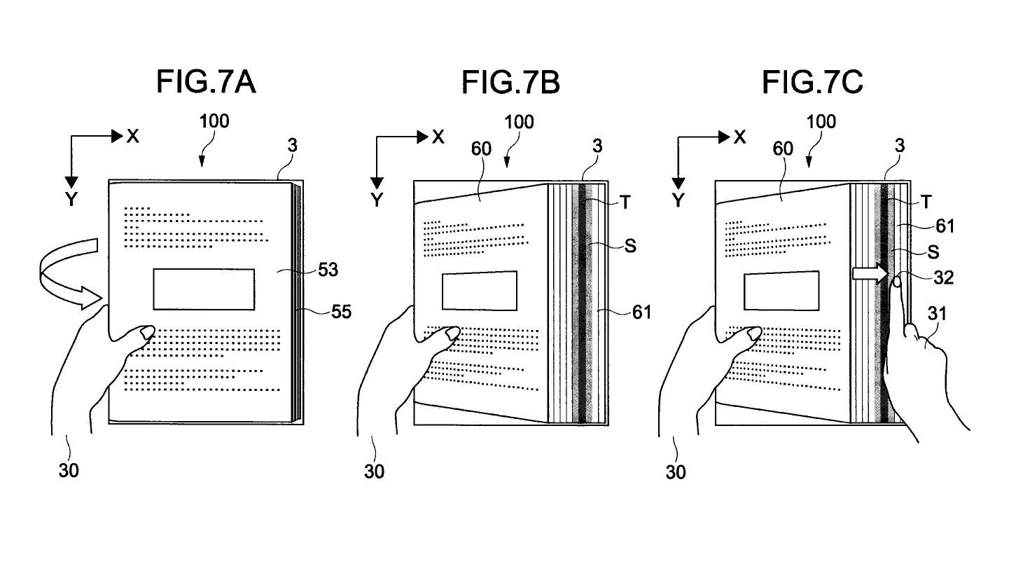

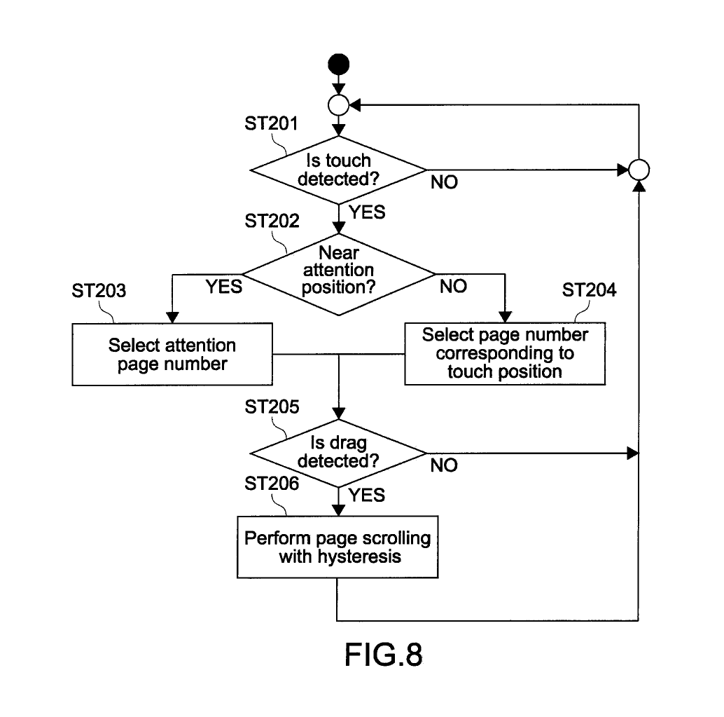

Next, the page scrolling process being as a page switching process by the portable terminal 100 according to this embodiment will be described. FIG. 7 are views each schematically showing a GUI for page scrolling according to this embodiment. As shown in FIG. 7A, under a state in which the display page 53 is displayed in a viewing mode, the user 30 may tilt the portable terminal 100 in a front direction being a direction in which the user 30 faces the display screen 3 (direction perpendicular to the sheet of FIG. 7).

The device provided in the inside of the portable terminal 100 may be capable of detecting the tilt. Detection of a change in tilt may trigger switching from the viewing mode to a page scrolling mode. As shown in FIG. 7B, on the display screen 3, an edge display image 60 being the GUI for page scrolling may be displayed.

The edge display image 60 may include an enlarged edge portion 61 obtained by enlarging the edge portion 55. In this embodiment, the enlarged edge portion 61 may be set as a page switching operation region being a region that receives successive page switching instructions. As shown in FIG. 7C, in accordance with a touch operation by the operator 31 with respect to the enlarged edge portion 61, the page scrolling process is performed. It should be noted that the size, the shape, and the like of the enlarged edge portion 61 may be appropriately set.

In this embodiment, based on a touch position 32 of the operator 31 in the enlarged edge portion 61, the number of the display page 53 being a page to be displayed on the display screen 3 is appropriately selected. Further, correspondingly to a change of the touch position 32 by a drag operation of the operator 31 in a right and left direction of the display screen 3 (X-direction in FIG. 7), the number of the display page 53 is successively updated. As information on the touch position 32, typically, coordinate information on the display screen 3 may be used. Hereinafter, the page scrolling process according to this embodiment will be described in detail.

FIG. 3 is a flowchart showing a flow of the page scrolling process using the portable terminal 100 according to this embodiment.

It may be determined whether or not a touch operation with respect to the enlarged edge portion 61 set as the page switching operation region is detected (Step 201). When it is determined that the touch operation is detected (Yes in Step 201), it may be determined whether or not the touch position 32 of that touch operation is located near an attention position T being a position corresponding to the attention page number (Step 202). The attention position T means such a position that the attention page number is selected as the display page number when the touch operation is performed, at the attention position T. That is, when at the attention position T the touch operation is performed, and then a page moving process is executed, the image of the attention page 57 is displayed on the display screen 3. The attention position T may be expressed by one coordinate value, for example, or expressed as a region having a width in the X-direction as shown in FIG. 7C. As the total number of pages of the electronic book 50 becomes larger, the size of the attention position T in the X-direction becomes smaller.

It should be noted that in FIGS. 78 and 7C, the attention position T may be colored or otherwise visually marked. In this manner, the attention position T may be displayed so as to be visually identified. Further, a mark indicating the attention position T may be displayed. However, the color coding, mark display, or the like for identifying the attention position T may not be performed.

When it is determined that the touch position 32 is located near the attention position (Yes in Step 202), an attention page number may be selected as a display page number (Step 203). That is, in this embodiment, a region from the attention position T up to a range in the right and left direction (X-direction) may be set as an attention region S. When the touch position 32 is included in the attention region S, it is determined that the touch position 32 is located near the attention position T. Accordingly, even when at a position different from the attention position T the touch operation is performed, if that touch position 32 falls within the attention region S, the attention page number is selected as the display page number. With this, it is possible for the display screen 3 to display the image of the attention page 57 as a page with good operability in a short time.

As shown in FIGS. 78 and 7C, the attention region S may also be colored. For example, the attention position T may be displayed in a red color, and the attention region S may be displayed in a blue color. Further, such a gradation display that within the attention region S, the color changes depending on a distance from the attention position T, may be employed.

When it is determined that the touch position 32 is not located near the attention position T (No in Step 202), a display page number corresponding to the touch position 32 is selected (Step 204).

It may be determined whether or not a drag operation by the operator 31 within the enlarged edge portion 61 is detected (Step 205). When the drag operation is not detected (No in Step 205), a page having the number selected in Step 203 or 204 may be displayed on the display screen 3. Alternatively, by performing a cancel process, the execution of the page scrolling process may be cancelled.

When the drag operation is detected (Yes in Step 205), the page scrolling process according to this embodiment, which will foe described in the following, is performed (Step 206). In this embodiment, the drag operation by the operator 31 corresponds to successive page switching instructions from the user 30.

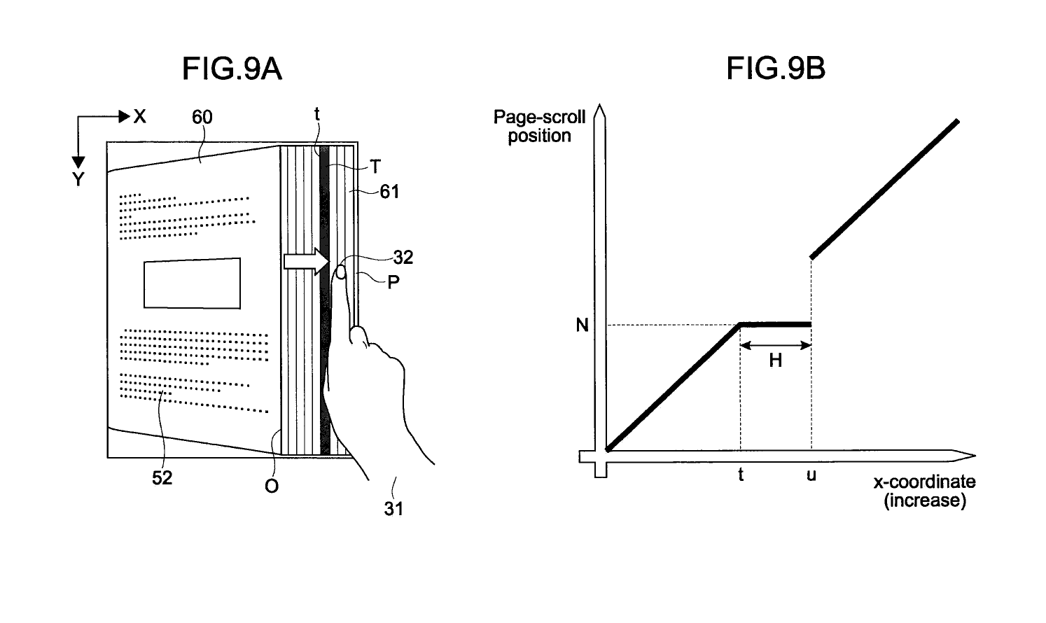

FIG. 9 are a view and a graph for describing updating of the display page number in the page scrolling process of this embodiment. Here, for the sake of easy understanding of the page scrolling-process, the description will be made of a case where a drag operation is performed in the X-direction from an end O on a left side to an end P on a right side of the enlarged edge portion 61 shown in FIG. 9A. A coordinate t shown in FIG. 9A is an x-coordinate of the attention position T, which corresponds to the attention page number. If the attention position T is expressed as a region, the coordinate t is an x-coordinate of a left end of the attention position T.

As shown in the graph of FIG. 9B, the touch position by the operator 31 may be dragged from the end O up to the end P, so that the x-coordinate of the touch position 32 increases successively. In response to the successive changes of the x-coordinate, the display page number may be successively updated. Here, when the touch position 32 is dragged up to the coordinate t of the attention position T, the updated display page number corresponds to an attention page number N.

When the updated display page number corresponds to the attention page number N, the updating of the display page number may be paused. With this, even if the operator 31 moves beyond the coordinate t of the attention position T, the state in which the attention page number N may be selected as the display page number is kept for a period of time. That is, as shown in FIG. 9B, even if during updating of the display page number, the touch position 32 is slightly beyond the coordinate t of the attention position T, as long as it falls within a hysteresis region H, the state in which the attention page number N is selected is kept due to a hysteresis.

In this embodiment, a period of time between a point in time when the updated display page number corresponds to the attention page number K and a point in time when the touch operation for page switching for a number of pages is executed, the updating of the display page number is paused. Accordingly, a region from the coordinate t of the attention position T up to a position coordinate u at which page switching for a number of pages by a drag operation is executed becomes the hysteresis region H.

However, the hysteresis region H having a size may be set on the display screen 3 with the coordinate t of the attention position T being as a reference. Alternatively, a period of time during which the updating of the display page number may be paused may be appropriately set. In the case where the paused period of time is set, the size of the hysteresis region H depends on the speed of the drag operation.

When the operator 31 is dragged beyond the hysteresis region H, the display page number corresponding to the touch position 32 by the operator 31 is updated.

When at the enlarged edge portion 61 the operator 31 is released, a page having the updated display page number may be displayed in the viewing mode on the display screen 3. When in the hysteresis region H shown in FIG. 9B, the operator is released, the image of the attention page 57 shown in FIG. 3 may be displayed on the display screen 3 in a pinpoint manner.

In the edge display image 60 shown in FIG. 9A, the content data 52 of the display page 53 shown in FIG. 1 is displayed. The content data 52 displayed in the edge display image 60 may be updated based on the updating of the display page number. That is, in the edge display image 60, the content data 52 of the page of the updated display page number may be successively displayed as preview images. In this case, when the updated display page number corresponds to the attention page number N, the updating of the content data 52 is paused. With this, the user 30 can view the content data 52 of the attention page continued being displayed in the edge display image 60, to thereby search for the attention page with good operability and high speed in a short time.

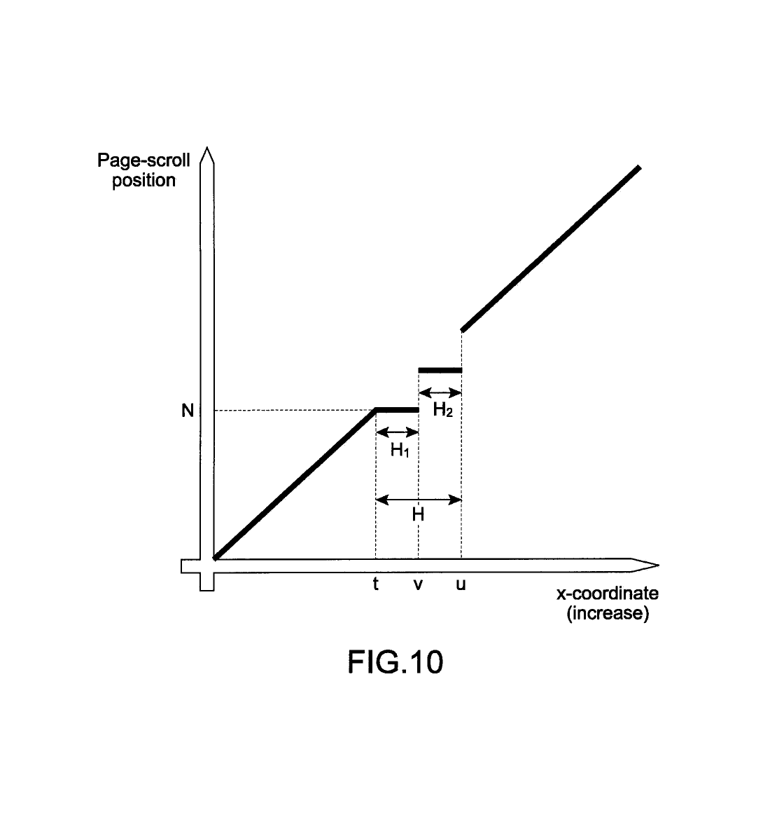

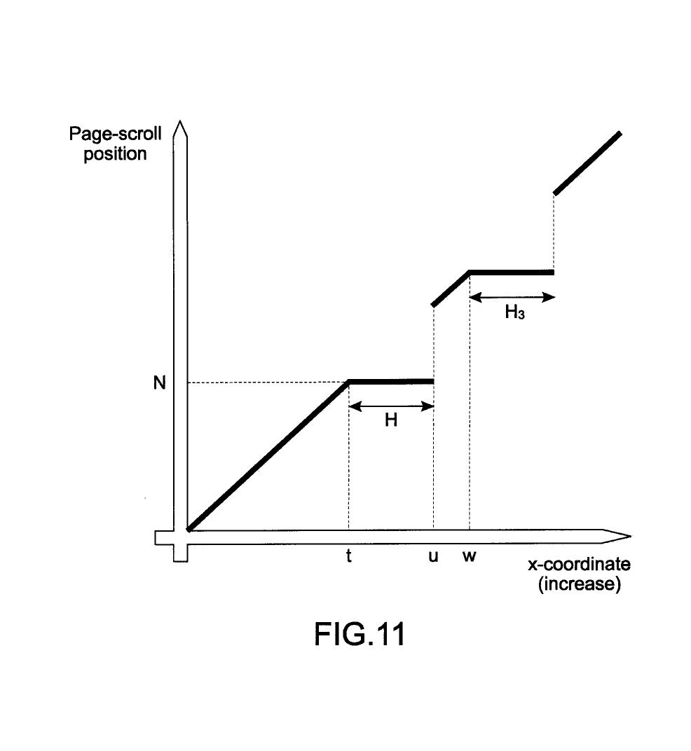

FIG. 10 and FIG. 11 are graphs each showing hysteresis regions in the case where a plurality of pages in the electronic book 50 are set as attention pages.

FIG. 10 is a graph showing the case where a page corresponding to a position coordinate v included in a hysteresis region H shown in FIG. 9 is set as an attention page. That is, the position coordinate v becomes an attention position coordinate v.

As shown in FIG. 10, separated hysteresis regions H₁ and H₂ are set from attention position coordinates t and v. In this embodiment, the hysteresis regions H₁ and H₂ may be set such that each has a size approximately equal to a half of the size of the hysteresis region H. In this example, the size of the hysteresis region H corresponds to a period of time until the touch operation is executed for page switching for a number of pages. Accordingly, the hysteresis regions H₁ and H₂ each corresponding to a period of time until the touch operation for approximately a half of the number of pages is executed are set. The ratio of the separation of the hysteresis region H can be appropriately set.

As shown in FIG. 11, in the case where a page corresponding to a position coordinate w, which is not included in the hysteresis region H that is set with respect to an attention position coordinate t, may be set as an attention page, it is sufficient that a hysteresis region H₃ that has a size approximately equal to the size of the hysteresis region H from the position coordinate w is set.

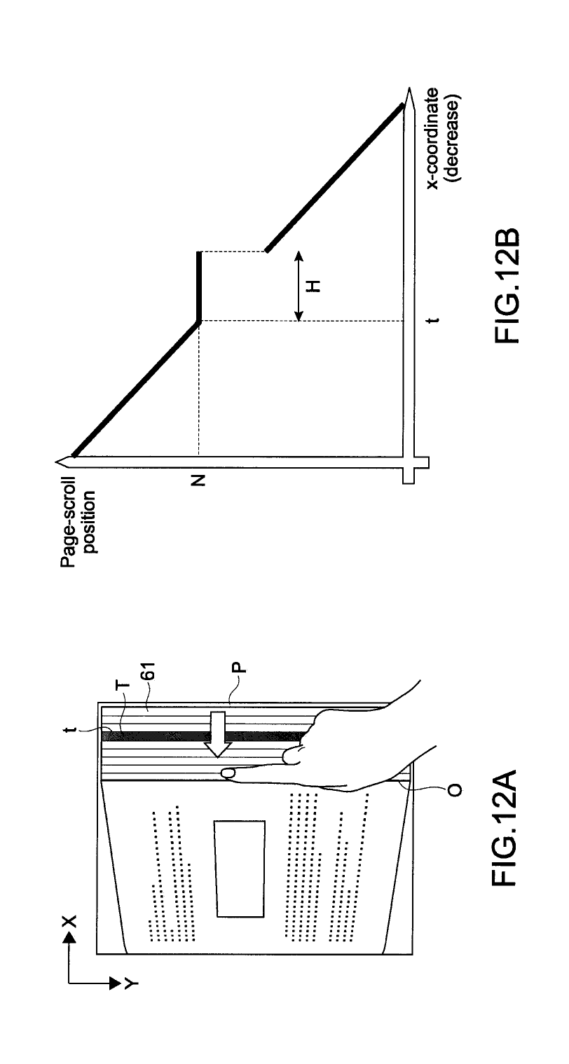

FIGS. 12A and 12B are a view and a graph snowing a case where a drag operation is performed in the X-direction from the end P on the right side up to the end O on the left side of the enlarged edge portion 61. That is, here, a page scrolling operation in an opposite direction is performed.

As shown in FIG. 12, in a case of the page scrolling operation in the opposite direction, updating is performed so that the display page number decreases successively along with a decrease of the x-coordinate. When the updated display page number corresponds to the attention page number N, a hysteresis region H may be set with the attention position coordinate t being as a reference. It should be noted that if the attention position T is expressed as a region, the attention position coordinate t is an x-coordinate on a right end of the attention position T. As described above, by setting the hysteresis region H, even in the page scrolling operation in the opposite direction, it is possible to search for the attention page being a desired page with good operability in a short time.

As described above, in the portable terminal 100 being as the information processing apparatus according to this embodiment, specification information that specifies the attention page number 11 is added to the electronic book 50. Then, in accordance with the successive page switching instructions, the display page number may be successively updated, and the successive updating of the display page number is paused when the display page number and the attention page number N corresponds to each other. Accordingly, for example, when the user 30 sets a desired page as the attention page, it is possible to search for the desired page having the attention page number N with good operability in a short time, and to display the image of the attention page 57 on the display screen 3.

Further, the page scrolling method according to this embodiment allows an intuitive page scrolling operation based on an action of making a dog ear with respect to a desired page, and then opening that page in a short time by the tactile sense in an actual electronic book.

### Second Embodiment

An information processing apparatus according to a second embodiment of the present disclosure will be described exemplifying a portable terminal. In the following, the descriptions of the same parts as the configurations and the actions of the portable terminal 100 described in the first embodiment will be omitted or simplified.

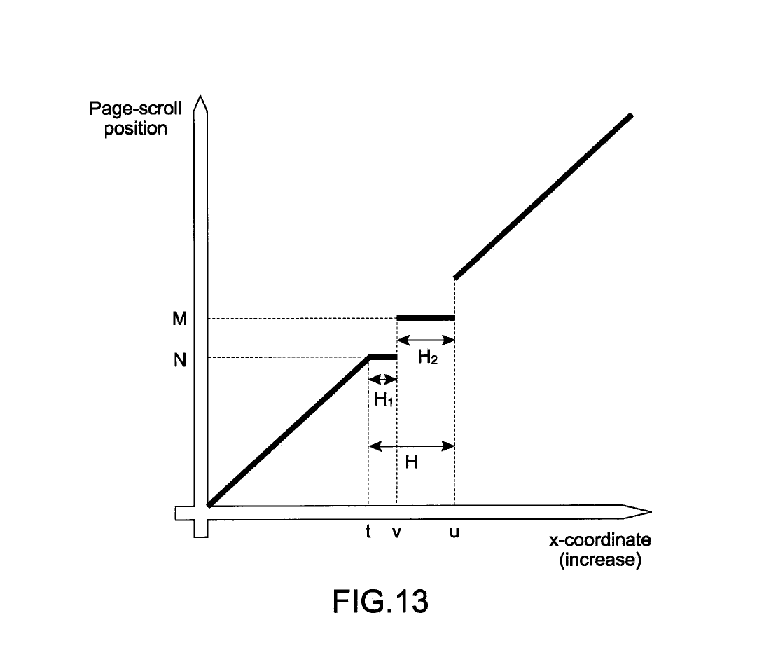

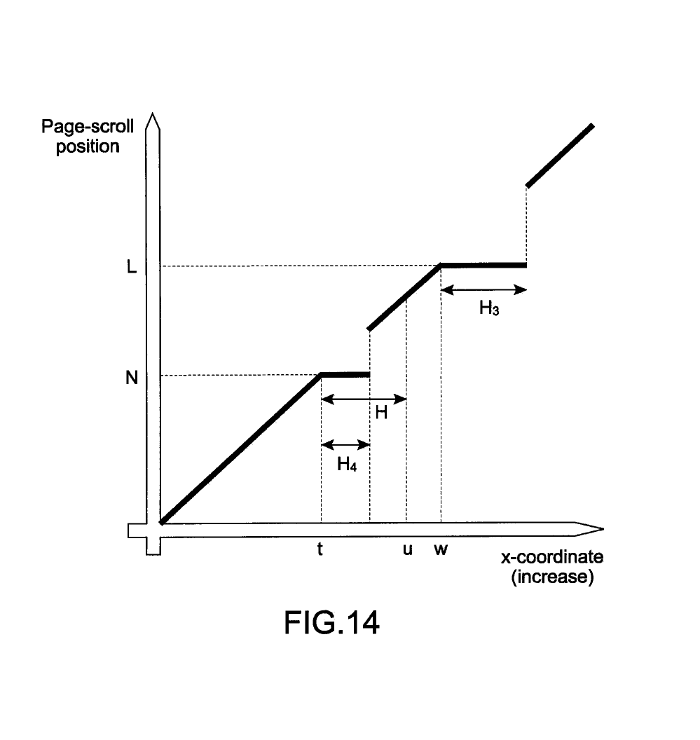

FIG. 13 and FIG. 14 are views showing hysteresis regions set by the portable terminal according to this embodiment. In this embodiment, when a page is set as the attention page, specification information that specifies the attention page number is added to the electronic book, and information on date and time when the specification information is added is added to the electronic book. For example, the date and time information is added into the bibliographic data of the electronic book while associated with the specification information. Alternatively, a management table may be generated.

FIG. 13 is a view showing a case where a hysteresis region H from an attention position coordinate t is set, and then a hysteresis region from an attention position coordinate v within the hysteresis region H is set. In this embodiment, the firstly set hysteresis region H may be divided so that the hysteresis regions H₁ and H₂ are set to extend from the attention position coordinates t and v, respectively. As shown in FIG. 13, the size of the hysteresis region H₁ newly set with respect to the attention position coordinate t corresponding to an attention page (number N) set at a later date and time is set to be larger than the size of the hysteresis region H₂ set with respect to the attention position coordinate v corresponding to an attention page (number M) set at an earlier date and time.

FIG. 14 is a view showing a case where a hysteresis region H from an attention position coordinate t is set, and then, a hysteresis region H₃ from the position coordinate w out of the hysteresis region H is set. In this embodiment, the hysteresis region H₃ having a size approximately equal to a hysteresis region H may be firstly set to extend from an attention position coordinate t is set to extend from an attention position coordinate w corresponding to a newly set attention page (number L). Then, a hysteresis region H₄ smaller than the hysteresis region H may be set to extend from the attention position coordinate t.

As described above, in this embodiment, taking the date and time when the specification information is added to the electronic book into consideration, the hysteresis regions, that is, a paused period of time of the updating of the display page number is adjusted. In this embodiment, an attention page according to specification information added at a later date and time is selected as a display page for a longer period of time. That is, searching for the newly set attention page becomes easier. With this, the user can select a desired page with good operability in a short time.

By selection by the user, an attention position coordinate according to specification information added at an earlier date and time may set to have a larger hysteresis region.

In this embodiment, taking the information on the date and time into consideration, the hysteresis region, that is, the paused period of time of the updating of the display page number may be adjusted. However, when the attention page is set, for example, the user may input information that indicates an attention degree, and based on the information indicating the attention degree, the size of the hysteresis region may be appropriately adjusted.

### Third Embodiment

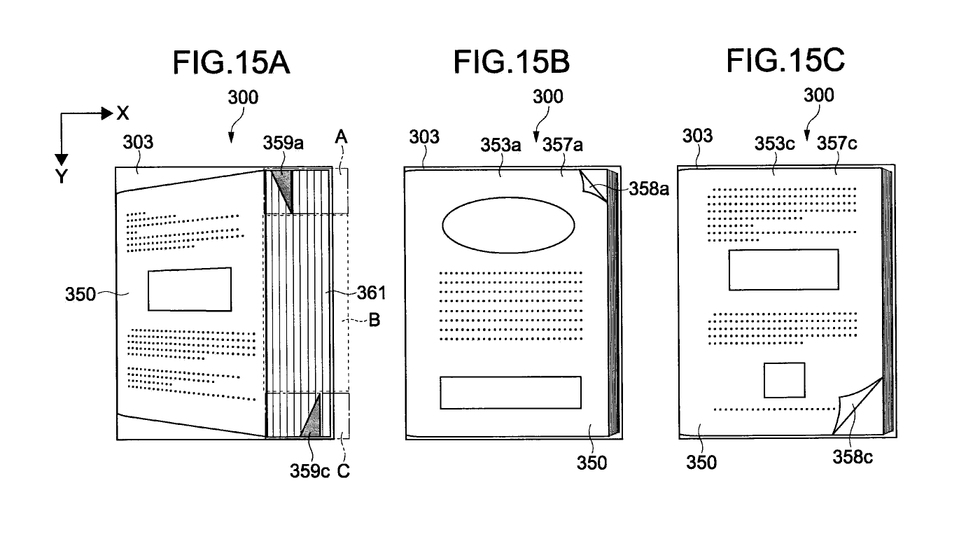

FIG. 15 are views schematically showing an edge display image to be displayed in a portable terminal being as an information processing apparatus according to the third embodiment of the present disclosure.

In a portable terminal 300 according to this embodiment, on a display screen 303, a plurality of page switching operation regions A, B, and C may be set. As shown in FIG. 15, the plurality of page switching operation regions A, B, and C may be provided so as to divide an enlarged edge portion 361 in a Y-direction. On an upper side of the enlarged edge portion 361, that is, a top side of an electronic book 350, a page switching operation region C may be set. Meanwhile, on a lower side of the enlarged edge portion 361, that is, a bottom side of the electronic book 350, a page switching operation region C may be set. Further, sandwiched between the page switching operation regions A and C, a page switching operation region B is set in the center of the enlarged edge portion 361. The user can add specification information corresponding to each of the page switching operation regions A, B, and C.

FIG. 15B shows an image of an attention page 357a corresponding to the page switching operation region A. For example, the user performs a setting operation for an attention page as shown in FIG. 6 in a region on a top side of a display page 353a. Then, the specification information corresponding to the page switching operation region A is added to the electronic book 350, and an image of the attention page 35a including a dog-ear portion 358a formed at an upper right end portion of the display page 353a is displayed.

FIG. 15C shows an image of an attention page 357c corresponding to the page switching operation region C. For example, the user may perform a setting operation for an attention page in a region on a bottom side of a display page 353c. Then, the specification information corresponding to the page switching operation region C is added to the electronic book 350, and an image of the attention page 357c including a dog-ear portion 358c formed at a lower right end portion of the display page may be displayed. It should be noted that the specification information corresponding to the page switching operation region B may not be added.

FIG. 15A shows marks 359a and 359c in the page switching operation regions A and C, the marks 359a and 359c indicating locations of the attention pages (attention positions). Images of such marks indicating the locations of the attention pages may be appropriately displayed on the display screen 303, or may not be displayed. Farther, for example, in order to indicate the location of the display page, a color is applied on the enlarged edge portion 361.

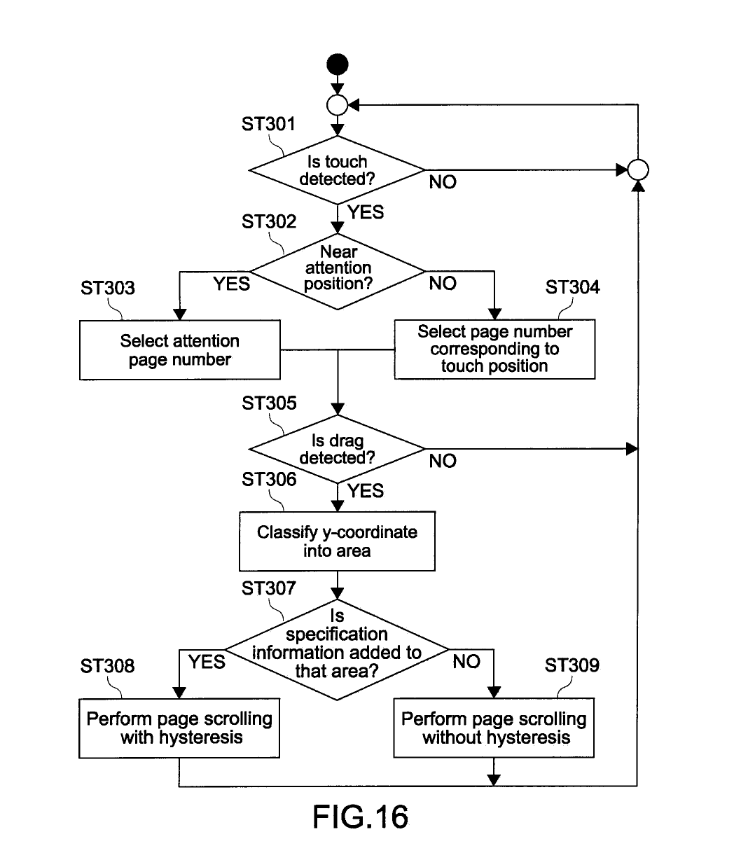

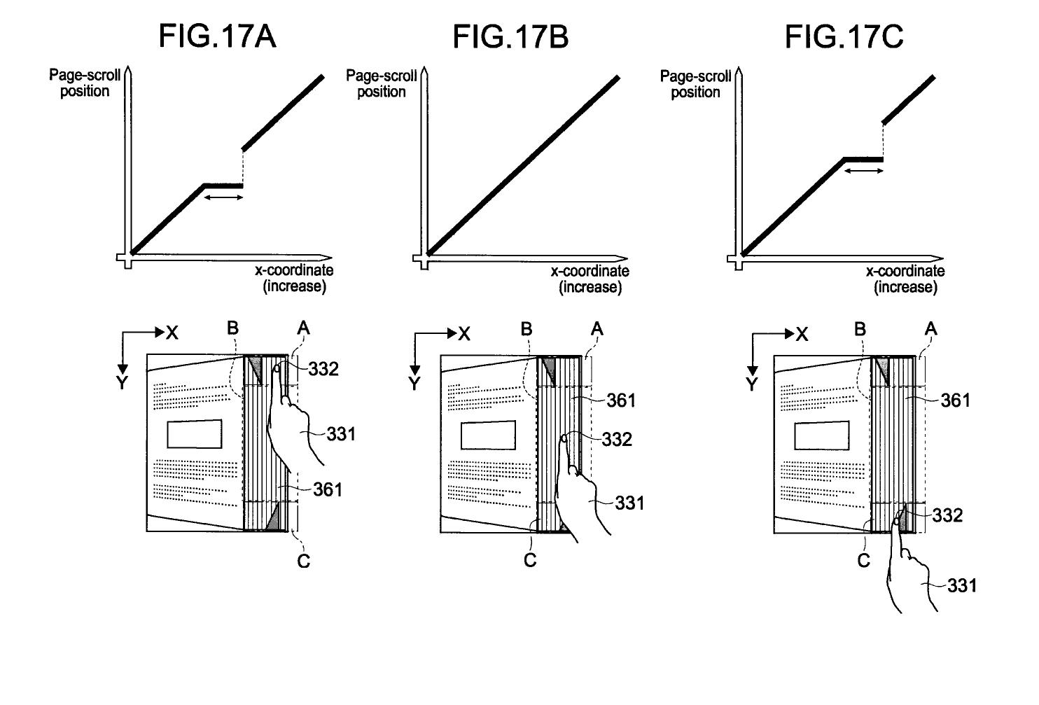

FIG. 16 is a flowchart showing a flow of a page scrolling process using the portable terminal 300. FIG. 17 are a view and a graph for describing the updating of the display page number in the page scrolling process of this embodiment.

First, when the touch operation with respect to the enlarged edge portion 361 is detected, and the touch position 332 falls within the attention region described in FIG. 7, the attention page number is selected as the display page number. When the touch position 332 is located out of the attention region, the number of the page corresponding to the touch position 332 may foe selected as the display page number (Step 301 to 304).

In this embodiment, in Step 301 to 304, the page switching operation regions A, B, and C where the touch position 332 is located need not be determined. That is, only an x-coordinate of the touch position 332, and not a y-coordinate, may be taken into consideration. When the x-coordinate of the touch position 332 is a value included in any one attention region of the page switching operation regions A, B, and C, the attention page number according to that attention region is selected as the display page number.

However, in Step 301 to 304, taking the y-coordinate of the touch position 332 into consideration, which of the page switching operation regions A, B, and C the touch position 332 belongs to may be determined. In this case, it is determined whether or not the touch position 332 is included in an attention region of a page switching operation region of the page switching operation regions, which includes the touch position 332. Then, when the touch position 332 is included in the attention region of that page switching operation region, the attention page number according to the attention region is selected as the display page number.

It may further be determined whether or not a drag operation by the operator 331 is detected in the enlarged edge portion 361 (Step 305). Then, based on the y-coordinate of the touch position 332, the page switching operation region including the touch position is determined (Step 306). Then, regarding each page switching operation region, whether specification information is added, that is, whether the attention page is set is determined (Step 307).

FIG. 17A is a view and a graph each showing a case where a drag operation is performed in the page switching operation region A. FIG. 17B is a view and a graph each showing a case where a drag operation is performed in the page switching operation region B. FIG. 17C is a view and a graph each showing a case where a drag operation is performed in the page switching operation region C.

As shown in FIGS. 17A and 17C, in the case where the drag operation is performed in the page switching operation region A or C (Yes in Step 307), the page scrolling process with a hysteresis may be performed (Step 308). As shown in FIG. 17B, in the case where the drag operation is performed in the page switching operation region B (No in Step 307), without the hysteresis, the page scrolling process in which the display page number is successively updated depending on a change of the touch position 332 is performed (Step 309).

As described above, in the portable terminal 300 of this embodiment, the plurality of page switching operation regions A, B, and C may be set on the display screen 303, and the specification information corresponding to each of the page switching operation regions A, B, and C may be added to the electronic book 350. With this, for example, the user can add the specification information corresponding to the page switching operation region A based on a certain theme, and add the specification information corresponding to the page switching operation region B based on a different theme. That is, depending on user-specified themes, for example, page searching operations can be performed. Alternatively, such a setting method that an attention page having high attention degree is set via the page switching operation region A, and an attention page having relatively low attention degree is set via the page switching operation region C is allowed. As described above, it becomes possible to search for a desired page for each page switching-operation region, and hence a page searching process with good operability and high speed can be realized.

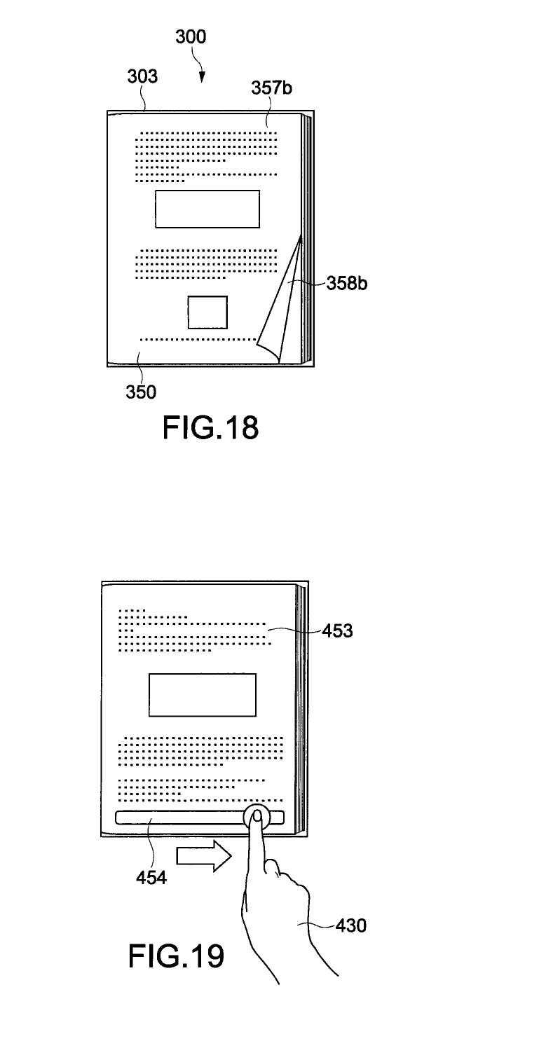

If should be noted chat the specification information corresponding to the page switching operation region B may be added to the electronic book 350. In this case, as shown in FIG. 18, an image of an attention page 357b including a dog-ear portion 358b formed at a position in the page switching operation region B. The position and the shape of the dog-ear portion 358b may foe appropriately set as long as it can be used for grasping that the attention page corresponds to each of the page switching operation regions A, B, and C. For example, the dog-ear portions are color-coded.

### Other Embodiments

The embodiments according to the present disclosure are not limited to the above-mentioned embodiments, and other various embodiments can be made.

In the above, in accordance with the setting operation for an attention page by the user, the specification information that specifies the attention page number is added to the electronic book. However, for example, a CPU may set a page as the attention page based on a parameter. For example, a display page having a display period of time over a period of time may be set as the attention page. That is based on an assumption that a page having a long display period of time is likely to have high attention degree. In addition, based on another assumption that a display page having high displaying frequency is considered as a page having high attention degree, such a page may be set as the attention page by the CPU. In addition to this, for example, a page having more image data than text data may be set as the attention page. With this, for example, in an electronic book with pages including only text data and pages including image data being mixed, the pages including the image data can be searched for with good operability. Otherwise, a parameter may be appropriately set depending on the content of the electronic book and the like.

Further, specification information added by another user who viewed the same electronic book may be added as it is. For example, in a system of downloading electronic books via the Internet, information on specification information added by each user to the electronic books is managed by a server within the system. Thus, when a user downloads an electronic book, specification information added by other users may be reflected on the electronic book. With this, for example, it becomes easy to grasp attention pages that attract the attention of many users or the like when page scrolling operations are performed. With this, the way of enjoying the electronic books is diversified, and further, popular pages can be searched for easily. In addition, the position information of the attention page and the like with respect to an electronic book can be shared and enjoyed among a plurality of users. Further, for example, based on an amount of comments to be added by the users with respect to a page, the attention page may be set. In addition to the amount of comments, an amount of collective intelligence added by the users, the attention page may be set.

Additionally, a method for so-called weighting for setting a page as the attention page can be appropriately set.

FIG. 19 is a view showing a modified example of the page switching operation region being a region that receives the successive page switching instructions from the user. In this modified example, in a lower part of a display page 453, a scroll bar 454 is displayed as a GUI component for displaying the page switching operation region. When a user 430 performs various touch operations with respect to the scroll bar 454, the page scrolling process to which the hysteresis described above is applied is executed. In addition to this, various GUI components for the page scrolling operation may be displayed on the display screen.

Further, as the input unit, for example, a touch pad provided separately from the display screen, a touch sensor provided on an outer edge of the display screen, or the like may be used. Any component may be used as the input unit as long as it is capable of receiving the successive page switching instructions from the user.

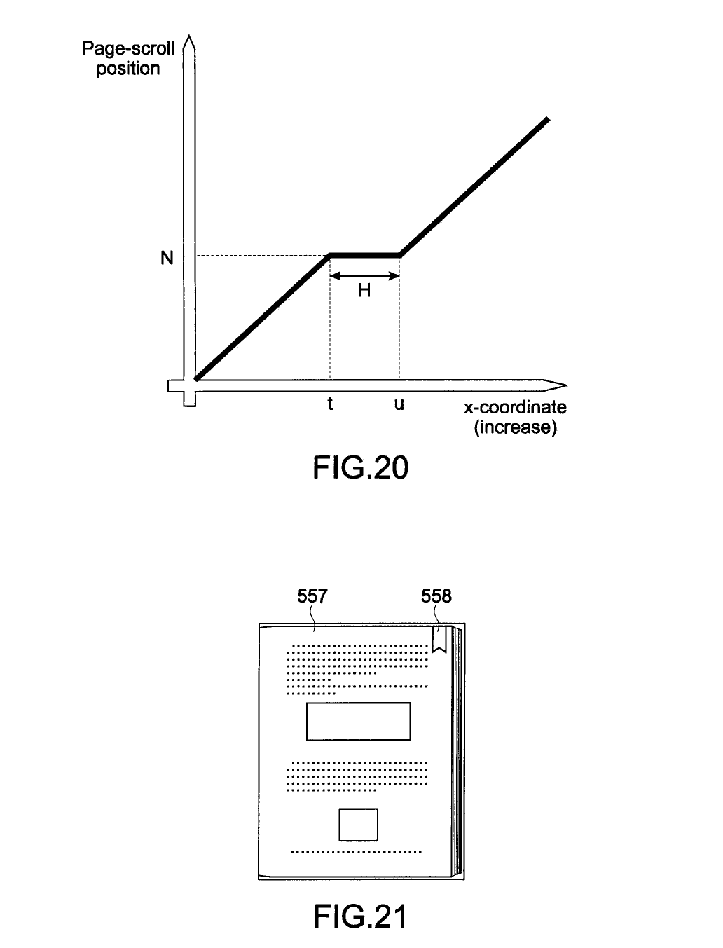

FIG. 20 is a graph showing a modified example regarding the updating of the display page number shown in FIG. 9. In the setting method for the hysteresis shown in FIG. 9, when the operator 31 is dragged beyond the hysteresis region H, the display page number corresponding to the touch position 32 of the operator 31 is updated. However, as shown in FIG. 20, when the operator 31 is dragged beyond the hysteresis region H, successive updating of the display page number may be restarted from the subsequent page number of the attention page number N. With this, the page scrolling operation with respect to all pages in the electronic book is allowed.

FIG. 21 is a view showing a modified example of an image of an attention page. An image of an attention page 557 of this modified example includes a book marker image 558 that expresses a book marker instead of the dog-ear portion. That is, the book marker image is added to a page that is set the user as the attention page. In addition to the book maker, a mark or a color for identifying the attention page may be added to the image of the attention page.

In the above, in accordance with the page scrolling operation, the display page number is selected and updated. The display page number may be a variable handled in internal processing and when the execution of the page moving process such as a release operation is determined, the display page is displayed on the display screen. However, during the selection and the updating of the display page number, the display page may be displayed on the display screen. For example, in accordance with a drag operation by the operator, a page-turn animation may be displayed, and the display page may be updated on the display screen.

In the above, the drag operation with respect to the page switching operation region corresponds to the successive page switching instructions from the user. However, for example, touch operations successively repeated with respect to the page switching operation region may be used as the successive page switching instructions from the user. Depending on the number of touch operations, the display page number is updated, and during a period of time between a point in time when the display page number and the attention page number correspond to each other and a point in time when a number of touch operations are performed, the updating of the display page number is paused. Otherwise, the operation method corresponding to the successive page switching instructions from the user can be appropriately set.

In the above, only one page is opened and displayed on the display screen. However, two pages may be opened and displayed on the display screen.

In the above, as shown in FIG. 1, in the viewing mode, the edge portion 55 of the display page 53 is displayed. The display of the edge portion 55 may be omitted, and the content data 52 may be displayed over the entire display screen 3 in the right and left direction. It is sufficient that during switching to the page scrolling mode, the enlarged edge portion 61 is displayed.

In the above, a page image expressing a page shape, a moving image when the dog-ear portion is made, and the like are displayed as a 3D animation image using a plurality of polygons. However, for example, a 2D animation image may be displayed using affine transformation.

The present disclosure contains subject matter related to that disclosed in Japanese Priority Patent Application JP 2010-228461 filed in the Japan Patent Office on Oct. 8, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An apparatus for displaying content stored as a plurality of pages, comprising:
a defection unit configured to detect a first user operation; and
a control unit configured to:
send signals to display one of the plurality of pages on a screen; and
when the detected first user operation comprises a page turn instruction:
send signals to sequentially change the displayed page at a first rate when the displayed page is outside a first number of pages before or after a first marked page; and
sequentially change the displayed page at a second rate slower than the first rate when the displayed page is within the first number of pages before or after the first marked page.

2. The apparatus according to claim 1, wherein the second rate is a rate at which the displayed page does not change until a second user operation is detected.

3. The apparatus according to claim 1, wherein the control unit is further configured to send signals to display a visual mark corresponding to the first marked page.

4. The apparatus according to claim 3, wherein the visual mark includes a visual representation of at least one of a bookmark, a page corner fold, or a sticky note.

5. The apparatus according to claim 1, wherein the detection unit is further configured to detect the first user operation via a touch screen.

6. The apparatus according to claim 5, wherein the control unit is further configured to send signals to display a page selection region on the touch screen and the detection unit is configured to detect a touch operation in the page selection region as the first-user operation.

7. The apparatus according to claim 6, wherein the detection unit is further configured to detect a sliding motion of a user control member as the first user operation.

8. The apparatus of claim 7, wherein the user control member comprises at least one of a finger, a stylus, or a pen.

9. The apparatus of claim 1, wherein the detection unit is configured to detect the first user operation via at least one of a button, a mouse, a trackball, a touchpad, a lever, a joystick, or a switch.

10. The apparatus of claim 1, wherein control unit is further configured to mark the first marked page in response to a touch operation made by the user.

11. The apparatus of claim 1, wherein the detection unit is further configured to determine whether or not the first user operation comprises a page turn instruction or a mark operation for marking a second marked page.

12. The apparatus of claim 11, wherein the control unit is further configured to send signals to mark the second marked page when the first user operation is a mark operation.

13. The apparatus of claim 11, wherein the detection unit is further configured to:
determine that a first touch operation has occurred by detecting the user control member within a proximity region;
detect whether or not the user control member exits the proximity region after the first touch operation;
determine that the first user operation comprises a page turn instruction when user control member exit of the proximity region is detected;
determine whether or not a second touch operation has occurred when user control member exit of the proximity region is not detected for a period of time after the first touch operation has occurred; and
determine that the first user operation comprises a mark operation when the second touch operation has occurred.

14. The apparatus of claim 1, wherein the control unit is further configured to, when the first user operation comprises a page turn instruction:
send signals to sequentially change the displayed page at a third rate when the displayed page is outside a second number of pages before or after a second marked page; and
sequentially change the displayed page at a fourth rate slower than the third rate when the displayed page is within the second number of pages before or after the second marked page.

15. The apparatus of claim 14, wherein the third rate is equal to the first rate and the fourth rate is equal to the second rate.

16. The apparatus of claim 14, wherein the first number of pages is equal to the second number of pages.

17. The apparatus of claim 14, wherein the control unit is further configured to send signals to display a first visual mark corresponding to the first marked page and a second, visual mark corresponding to the second marked page.

18. The apparatus of claim 17, wherein the first visual mark comprises a first color and the second visual mark comprises a second color, the first and second colors being different.

19. A method comprising:
detecting a first user operation;
displaying one of a plurality of pages of content on a screen;
when the detected first user operation comprises a page turn instruction;
sequentially changing the displayed page at a first rate when the displayed page is outside a first number of pages before or after the marked page; and
sequentially changing the displayed page at a second rate slower than the first rate when the displayed page is within the first number of pages before or after the marked page.

20. A tangibly embodied non-transitory computer-readable medium storing instructions which, when executed by a processor, perform a method comprising:
detecting a first user operation;
displaying one of a plurality of pages of content on a screen;
when the detected first user operation comprises a page torn instruction:
sequentially changing the displayed page at a first rate when the displayed page is outside a first number of pages before or after the marked page; and
sequentially changing the displayed page at a second rate slower than the first rate when the displayed page is within the first number of pages before or after the marked page.
